(19) United States
(12) Patent Application Publication
(10) Pub. No.: US 2011/0018149 A1
(43) Pub. Date: Jan. 27, 2011

(54) OPTICAL FILM AND METHOD AND APPARATUS FOR MANUFACTURING THE SAME

(75) Inventor: Kenichi Kazama, Hyogo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/933,842

(22) PCT Filed: Mar. 18, 2009
(86) PCT No.: PCT/JP2009/055288

§ 371 Date: Sep. 21, 2010

(30) Foreign Application Priority Data
Mar. 27, 2008 (JP) 2008083321

(51) Int. Cl. B29D 11/00

(52) U.S. Cl. 264/1.6; 425/404

(57) ABSTRACT

Disclosed is a method of manufacturing an optical film in which thickness unevenness and optical distortion are sufficiently prevented, employing a melt casting film formation method. The method is one manufacturing an optical film by extruding a melted film forming composition containing a thermoplastic resin from lip portions of a casting die to form a melted product in the form of a film and then holding the resulting melted product between a pair of rotary rollers thereby cooling and solidifying the melted product, wherein the method comprises heating a shield plate, which is provided in the vicinity of an inlet of a nip of the pair of rotary rollers and in the vicinity of the surface of at least one of the pair of rotary rollers, thereby heating an air stream occurring upon rotation of the rotary rollers.

### FIELD OF THE INVENTION

This invention relates to an optical film, and a method and an apparatus for manufacturing the optical film.

### TECHNICAL BACKGROUND

Since a liquid crystal display is more space saving and energy saving than a conventional CRT display, it is widely used as a monitor. Further, it spreads for TV use. Such a liquid crystal display employs various types of optical films including a polarizing film or a phase difference film.

These optical films are required to be uniform in thickness and retardation without thickness unevenness or optical distortion. Particularly, as size and definition of monitors and TVs increase, the qualities required are getting higher.

The optical film manufacturing method can be broadly classified into a melt casting film formation method and a solution casting film formation method. The former method is one which manufactures a film by heating a polymer to melt, and casting the melted polymer on a support member to cool and solidify, optionally followed by stretching. The latter method is one which manufactures a film by dissolving a polymer in a solvent, casting the resulting polymer solution on a support member, and evaporating the solvent, optionally followed by stretching. In either method, the melted polymer or polymer solution is cooled or dried on the support member and solidified to form a polymer film. After having been separated from the support member, the resulting polymer film is subjected to drying or stretching treatment while being conveyed by a plurality of conveyance rollers.

The solution casting film formation method has problem in that it has a high environmental load due to use of a large amount of solvent. On the other hand, the melt casting film formation method is expected to improve productivity, since it does not use any solvent. The melt casting film formation method is preferably used from the point of view of environmental protection. However, this method has disadvantage that it is great in thickness unevenness and optical distortion, as compared with the solution casting film formation method.

As a method improving thickness uniformity in the melt casting film formation method, there is disclosed, for example, a thermoplastic resin film manufacturing method comprising the steps of extruding a melted thermoplastic resin in the form of a sheet from a die, and holding the sheet between a pair of rollers in which at least one of the rollers is made of a metal, thereby cooling and solidifying the sheet to form a film, wherein a suction chamber, which is provided in the vicinity of a nip where the sheet is held between the pair of rollers and in the vicinity of the surface of at least one of the pair of rollers, sucks a flowing air occurring with rotation of the pair of rollers (Patent Document 1).

However, even when the technique disclosed in Patent document 1 is used, an optical film having an optical property sufficient to respond to extreme demand for quality of the market cannot be obtained. That is, collision of the flowing air with the melted product cannot be completely prevented, and temperature lowering of the melted product is relatively great and non-uniform. Therefore, in the thus obtained optical film, the thickness unevenness or optical distortion is not sufficiently prevented.

Further, a film formation method is disclosed which continuously ejects a melted thermoplastic resin from a die toward the lower side of the die, and holding the melted resin between two rotating cooling rollers capable of cooling to a temperature not higher than Tg of the resin to form a film, wherein enforced ventilation is carried out at a position which is below the horizontal line through a point where the two rotating cooling rollers are closest to each other, and which is under that point (Patent Document 2). This enforced ventilation prevents deposition or accumulation of volatile components. In the above method, there are proposed a method in which the enforced ventilation as described above is carried out between a covering material and the two cooling rollers, the covering material being provided distant from the two cooling rollers and a method in which a covering material is heated, the covering material being provided at a position above the horizontal line including a point where the two rotating cooling rollers are closest to each other. However, these methods also do not prevent the thickness unevenness or optical distortion of an optical film obtained.

### Patent Document 1: Japanese Patent O.P.I. Publication No. 2007-160628

### Patent Document 2: Japanese Patent O.P.I. Publication No. 2007-125833

### DISCLOSURE OF THE INVENTION

### Problems to be Solved by the Invention

An object of the invention is to provide an optical film in which thickness unevenness and optical distortion are sufficiently prevented, and to provide a method and an apparatus for manufacturing the optical film employing a melt casting film formation method.

### Means for Solving the Above Problems

The present invention has been attained by any one of the following constitutions 1 to 9.

1. A method of manufacturing an optical film by extruding a melted film forming composition containing a thermoplastic resin from lip portions of a casting die to form a melted product in the form of a film and then holding the resulting melted product between a pair of rotary rollers thereby cooling and solidifying the melted product, wherein the method comprises heating a shield plate, which is provided in the vicinity of an inlet of a nip formed between the pair of rotary rollers and in the vicinity of the surface of at least one of the pair of rotary rollers, thereby heating an air stream occurring upon rotation of the rotary rollers.

2. The method of manufacturing an optical film of item 1 above, wherein the shield plate provided in the vicinity of the surface of the rotary roller is in the form of an arc concentric with the rotary roller in the cross-section perpendicular to the axis direction of the rotary rollers.

3. The method of manufacturing an optical film of item 1 or 2 above, wherein a clearance between the rotary roller and the shield plate provided in the vicinity of the surface of the rotary roller is from 0.5 to 10 mm.

4. The method of manufacturing an optical film of any one of items 1 through 3 above, wherein the shield plate provided in the vicinity of the surface of the rotary roller has a length of from 10 to 300 mm in the rotation direction of the rotary roller.

5. The method of manufacturing an optical film of any one of items 1 through 4 above, wherein the shield plate is heated to from 80 to 260° C.

6. The method of manufacturing an optical film of any one of items 1 through 5 above, wherein gas containing a sublimate generated from the melted product extruded from the lip portions is sucked through a suction nozzle disposed on one or both sides of the lip portions over the entire length of the lip portions.

7. The method of manufacturing an optical film of item 6 above, wherein the suction nozzle is disposed between the shield plate and the casting die.

8. An optical film manufactured according to the method of any one of items 1 through 7 above.

9. An apparatus of manufacturing an optical film by extruding a melted film forming composition containing a thermoplastic resin from lip portions of a casting die to form a melted product in the form of a film and then holding the resulting melted product between a pair of rotary rollers thereby cooling and solidifying the melted product, wherein the apparatus comprises a shield plate to be heated which is provided in the vicinity of the surface of at least one of the pair ofrotary rollers and in the vicinity of an inlet of a nip formed between the pair of rotary rollers, the melted product being held at the nip.

### EFFECTS OF THE INVENTION

In the present invention, a shield plate is provided at a pre-determined position and the shield plate is heated, whereby the air stream, which collides with the melted product, is reduced and efficiently heated. Accordingly, temperature lowering due to the air stream of the melted product, which is extruded from the lip portions of the die, is restrained. As a result, an optical film, which prevents thickness unevenness or optical distortion thereof, can be obtained.

### BRIEF EXPLANATION OF THE DRAWINGS

FIG. 1 is a schematic drawing of one embodiment of an apparatus for carrying out the optical film manufacturing method in the invention.

FIG. 2 is a drawing in which the main sections from a casting die to a rotary roller for cooling in FIG. 1 are enlarged.

FIG. 3 is a drawing in which the vicinity of the lip portions in FIG. 2 is enlarged.

FIG. 4 is a perspective view showing the outline of the structure in which a liquid crystal display is decomposed.

### EXPLANATION OF SYMBOLS

1: Extruder
2: Filter
3: Static mixer
4: Casting die
5: First rotary roller (first cooling roller)
6: Second rotary roller (touch roller)
7: Second cooling roller
8: Third cooling roller
9, 11, 13, 14, and 15: Conveyance rollers
10: Unstretched film
12: Stretching device
16: Winding device
21a and 21b: Protective films
22a and 22b: Phase difference films
23a and 23b: Delayed axis directions of film
24a and 24b: Transmission axis directions of film
25a and 25b: Polarizers
26a and 26b: Polarizing plates
27: Liquid crystal cell
29: Liquid crystal display
41a and 41b: Lip portions
42: Melted product
45a and 45b: Shield plates
46a and 46b: Flowing directions of air stream
47: Nip
70: Local ventilation device
71: Suction nozzle
72: Ventilation fan
73: Cooling device
74: Filter
75: Differential pressure meter
76: Pipe
77: Heater

### PREFERRED EMBODIMENT OF THE INVENTION

### Optical Film Manufacturing Method And Apparatus

The method and apparatus of manufacturing an optical film in the invention employ so-called a melt casting method. That is, the optical film is manufactured by extruding a melted film forming composition containing a thermoplastic resin from a lip portion of a casting die to form a melted product in the form of a film and holding the resulting melted product between a pair of rotary rollers to cool and solidify the melted product.

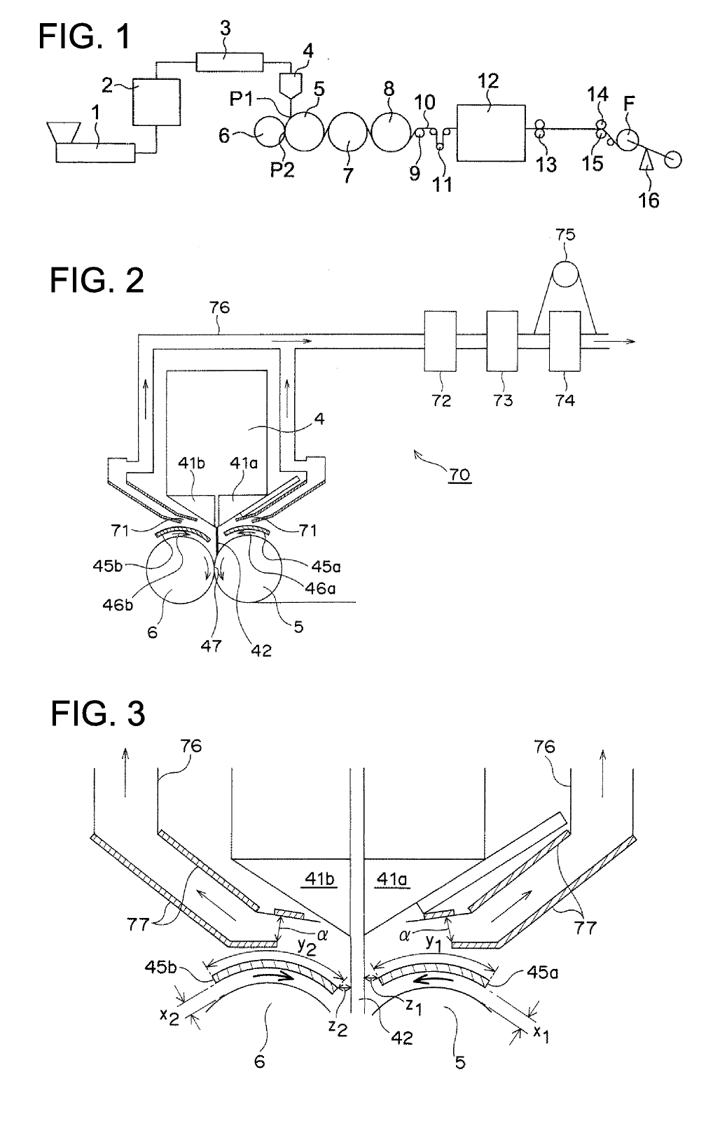

The method of the invention of manufacturing an optical film comprises a melt extrusion step, and ordinarily further comprises a stretching and winding step. Next, each step will be explained in detail employing FIGS. 1 through 3. FIG. 1 is a schematic illustration showing one embodiment of an apparatus carrying out the method of the invention of manufacturing an optical film. FIG. 2 is an illustration in which the main sections from a casting die to a rotary roller for cooling in FIG. 1 are enlarged. FIG. 3 is an illustration in which the main sections in the vicinity of the lip portions in FIG. 2 are enlarged. The numerical numbers shown in common in FIG. 1 through 3 represent the same.

### (Melt Extrusion Step)

In this step, materials including a thermoplastic resin constituting a film are mixed and melted in the extruder 1, optionally passed through the filter 2 and the static mixer 3, and extruded from the casting die 4 onto the first rotary roller 5 to form the melted product 42 in the form of a film. In this step, the melted product 42 in the form of a film is brought into contact with the first rotary roller 5 under predetermined circumstances and pressed onto the surface of the first rotary roller 5 at a given pressure through the second rotary roller 6. The first rotary roller 5 constitutes one of the pair of rotary rollers described above and is called a first cooling roller or a cooling drum. The second rotary roller 6 constitutes the other one of the pair of rotary rollers described above and is called a touch roller.

Specifically, as shown in FIG. 2, the melted product 42 is extruded in the form of a film from the lip portions 41a and 41b and held by a pair of rotary rollers 5 and 6, during which the air streams 46a and 46b colliding with the extruded melted product 42 is heated through the shield plates 45a and 45b, and at the same time, the shield plates 45a and 45b reduce a generation amount of the air streams 46a and 46b. The air streams 46a and 46b inevitably occur with rotation of the rotary rollers 5 and 6, however, the shield plates 45a and 45b limit an air amount contributing to generation of the air stream, resulting in reduction of the generation amount of the air stream. Further, as the shield plates 45a and 45b are heated to a pre-determined temperature, the air streams 46a and 46b are heated when they pass between the shield plates 45a and 45b and the rotary rollers 5 and 6. Therefore, temperature lowering of the melted product, with which the air stream collides, is restrained, whereby the melted product has a relatively uniform temperature, particularly in the width direction thereof. As a result, an optical film whose thickness unevenness or optical distortion is sufficiently restrained can be obtained.

The shield plate herein refers to a plate which shields air incorporated on generation of the air stream.

As shown in FIG. 2, the shield plates 45a and 45b are provided in the vicinity of the inlet of the nip 47 in the pair of rotary rollers 5 and 6 and in the vicinity of the surface of the rotary rollers 5 and 6. Specifically, the shield plates 45a and 45b are provided at a pre-determined clearance in the direction of the diameter of the rotary rollers 5 and 6 between the rotary rollers 5 and 6 and the casting die. In FIG. 2, the shield plate is provided in the vicinity of the surfaces of both of the rotary rollers 5 and 6, but it may be provided in the vicinity of the surface of one of the rotary rollers. The nip 47 is a portion between the pair of the rotary rollers at which the melted product 42 is held. Next, the shield plates 45a and 45b will be explained in detail, and they can be independently selected and provided.

The shape of the shield plates 45a and 45b are not specifically limited as long as they can heat the air stream and reduce the amount, and may be, for example, in the form of a curved plate or in the form of a planar plate. The shape of the shield plate 45a (or 45b) is preferably in the form of a curved plate from a viewpoint of sufficiently minimizing thickness unevenness or optical distortion of an optical film. It is especially preferred that as shown in FIG. 2, the shape of the shield plate 45a (or 45b) provided in the vicinity of the surface of the rotary roller 5 (or 6) is in the form of an arc concentric with the rotary roller 5 (or 6) in the cross-section perpendicular to the axis of the rotary roller 5 (or 6).

The clearance x₁ or x₂ (see FIG. 3) between the rotary roller and the shield plate disposed in the vicinity of the rotary roller surface is not specifically limited, and may be, for example, from 0.3 to 25 mm. The clearance is preferably from 0.5 to 10 mm, and more preferably from 0.5 to 3 mm, from a viewpoint of more sufficiently minimizing thickness unevenness or optical distortion of an optical film.

The size of the shield plate 45a (or 45b) is not specifically limited, and is ordinarily determined according to that of the rotary roller 5 (or 6). For example, when the diameter of the rotary roller 5 (or 6) is from 200 to 1000 mm, the length y₁ or y₂ (see FIG. 3) of the shield plate 45a (or 45b) in the rotation direction of the rotary roller 5 (or 6) may be from 3 to 400 mm, and the length is preferably from 10 to 400 mm, and more preferably from 30 to 400 mm, from a viewpoint of more sufficiently minimizing thickness unevenness or optical distortion of an optical film. The length in the direction perpendicular to the page in FIG. 2 of the shield plate 45a (or 45b) is not shorter than that of the lip portion 41a or 41b.

It is preferred that the distance z₁ or z₂ (see FIG. 3) between the shield plate 45a (or 45b) and the melted product 42 in the form of a film extruded from the lip portions 41a and 41b is from 1 to 100 mm, and especially from 10 to 30 mm, from a viewpoint of more sufficiently minimizing thickness unevenness or optical distortion of an optical film.

The heating temperature of the shield plate 45a (or 45b) is not specifically limited as long as temperature lowering of the melted product 42 due to the air stream is restrained, and may be ordinarily from 50 to 300° C. The heating temperature is preferably from 80 to 260° C., from a viewpoint of more sufficiently minimizing thickness unevenness or optical distortion of an optical film. The heating means (not illustrated) for the shield plate 45a (or 45b) is not specifically limited, and may be, for example, a cartridge heater.

Material for the shield plate 45a (or 45b) is not specifically limited, as long as it is heat resistant to such an extent that it does not deform on heat application. Examples of the material for the shield plate 45a (or 45b) include stainless steel, aluminum, copper and resin.

Preferred examples of the first rotary roller 5 or the second rotary roller 6 include carbon steel, stainless steel, resin and the like. In addition, the surface accuracy of the rollers is preferably high, and the surface roughness thereof is preferably 0.3 S or less, and more preferably 0.1 S or less. It is preferred that the second rotary roller 6 is pressed through a pressing means to press a film onto the first rotary roller 5. At this time, the linear pressure, with which the second rotary roller 6 presses the film on the first rotary roller 5, can be adjusted by an air pressure piston or the like, and is preferably from 0.1 to 100 kgf/cm and more preferably from 1 to 50 kgf/mm.

The surface temperature of the first rotary roller 5 or the second rotary roller 6 is not specifically limited. The surface temperature of the first rotary roller 5 is ordinarily from 80 to 150° C., and preferably from 100 to 130° C., and the surface temperature of the second rotary roller 6 ordinarily from 80 to 150° C., and preferably from 100 to 130° C.

The first rotary roller 5 or the second rotary roller 6 may be processed so as to reduce the diameter of both ends of the roller or to have a flexible surface, in order to enhance its uniform contact with a film.

In the preferred embodiment of the invention, it is preferred that the suction nozzle 71 is provided along the entire length of the lip portion on one side or each side of the lip portions 41a and 42b, as shown in FIG. 2, whereby gas including a sublimate generated from the melted product 42 is sucked. The suction nozzle 71, which is provided between the shield plates 45a and 45b and the casting die 4, constitutes a part of a local ventilation device 70.

As is shown in FIG. 2, the local ventilation device 70 is composed of a suction nozzle 71 disposed in the vicinity of the lip portions 41a and 41b of the tip of the casting die 4, a ventilation fan 72 for sucking gas including a sublimate generated from the vicinity of the lip portions 41a and 41b through the suction nozzle 71, a cooling device 73 for cooling the gas exhausted from the ventilation fan 72, a filter 74 for removing foreign matter contained in the gas from the cooling device 73, a differential pressure meter 75 for measuring a difference between a pressure on the inlet side of the filter 74 and that on the outlet side of the filter 74, and a pipe 76 for discharging in the atmosphere the gas sucked by the nozzle 71. This pipe (gas pipe) 76 is designed so that the sublimated gas is not brought into direct contact with the die lip. The pipe being independently heated, accumulation in the pipe of the sublimate derived from cellulose as a material can be prevented.

During the step as described above in which the gas containing the sublimate sucked from the suction nozzle 71 is removed, incorporation of the step of cooling the heated gas in the cooling device 73 makes it possible to efficiently remove the sublimate for a long term. Accordingly, an optical film without foreign matter fault can be manufactured for a long term.

Accumulation in the pipe of the sublimate is further minimized by making the area of the opening of the suction nozzle smaller than that of the section of the pipe.

Any cooling method can be used in the cooling device 73 as long as it is one capable of cooling gas in the pipe 76. As the cooling method, there is mentioned, for example, a method in which outside air is introduced around the pipe 76, a method employing a Peltier element, a method employing a refrigeration circuit, or a method employing cold water.

Cooling temperature to which is cooled according to the cooling device 73 is preferably from 10° C. to 50° C. The cooling temperature exceeding 50° C. is likely to cause deposition to the filter 74 of the sublimate, while the cooling temperature of less than 10° C. causes deposition to the cooling device of the moisture in air to be exhausted, which makes it difficult to remove the sublimate.

The suction opening of the suction nozzle 71 is preferably provided at a position 100 mm or less distant from the tip of the lip portions 41a and 41b. Provision of the suction opening more than 100 mm distant from the lip portion tip cannot sufficiently suck gas generated. The wind velocity at the nozzle tip having the suction opening of the nozzle 71 is preferably from 0.1 to 1 m/min. The wind velocity is preferably uniform in the width direction (also referred to as TD direction) of the film and deviation of the wind velocity in the width direction is preferably within ±30%, and more preferably within ±10%. It is important that the slit clearance of the nozzle tip is uniform in the width direction. The suction nozzle is set so that the velocity of the wind is uniform in the width direction. The suction nozzle 71 in FIG. 2 or FIG. 3 may be in the form of a continuous slit in the width direction or in the from of divided slits in the width direction. The suction nozzle with the divided slits is easy in incorporation to a device and in maintenance. The wind velocity, as long as it is within the range described above, is not limited thereto.

The slit clearance α at the tip of the suction nozzle 71 is preferably from 3 mm to 30 mm, and more preferably from 5 mm to 15 mm. The deviation in the width direction of the slit clearance α is preferably within 10%, and more preferably within 5%. Further, it is important that the wind velocity does not vary. When the wind velocity at a given position is measured, the variation of the wind velocity is in the range of preferably ±30%, and more preferably 10%.

It is preferred that the heater 77 as shown in diagonal lines in FIG. 3 is provided around the suction nozzle 71 in order to prevent the generated sublimation gas from being rapidly cooled to deposit to the surroundings of the lip portions 41a and 41b. The temperature of the heater is preferably from 80° C. to 250° C., and more preferably from 110° C. to 200° C. The heater 77 is preferably a gum heater, a cartridge heater or a cast-in aluminum heater, but is not limited thereto. The gum heater is especially preferred.

The materials constituting the optical film of the invention comprise at least a thermoplastic resin and optionally a stabilizer, a UV absorbent, a matting agent as a lubricant or a retardation controlling agent. These materials are appropriately selected according to performance required in an intended optical film.

As the thermoplastic resin, there can be used a resin conventionally used in optical film fields, and cellulose resin is preferably used, for example. The cellulose resin has a cellulose ester structure, and preferably is a single acid ester or a mixed acid ester of cellulose each having at least one selected from an aliphatic acyl group and a substituted or unsubstituted aromatic acyl group.

Typical examples of the cellulose resin include cellulose acetate, cellulose propionate, cellulose butyrate, cellulose acetate propionate, cellulose acetate butyrate, cellulose acetate phthalate and cellulose phthalate. Of these, especially preferred cellulose resin is cellulose acetate, cellulose propionate, cellulose butyrate, cellulose acetate propionate, or cellulose acetate butyrate. The cellulose resin may be used singly or as an admixture of two or more kinds thereof.

Cellulose acetate propionate or cellulose acetate butyrate, which is a mixed aliphatic acid cellulose ester, has an acyl group having 2 to 4 carbon atoms as the substituent.

When X represents a degree of substitution of the acetyl group, and Y represents a degree of substitution of the propionyl group or the butyryl group, it is preferred that cellulose acetate propionate or cellulose acetate butyrate satisfies both Formula (I) and Formula (II) below. The degree of substitution is defined as the number of hydroxyl groups substituted with an acyl group per one glucose unit.

b 2.6≦X+Y≦3.0 Formula (I)

0≦X≦2.5 Formula (II)

Cellulose acetate propionate is preferably used, and cellulose acetate propionate, which satisfies formulas 1.9≦X≦2.5 and 0.1≦Y≦0.9, is especially preferred. The portion of the cellulose resin, which is not substituted with an acyl group, is usually a hydroxyl group.

The cellulose resin can be synthesized by a known method.

Cellulose which is a raw material for the cellulose resin used in the invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose resins made from these substances may be suitably blended or used alone.

The molecular weight of the cellulose resin is not specifically limited and the number average molecular weight of the cellulose resin is from 60,000 to 200,000, and preferably from 70,000 to 120,000.

In order to remove foreign matter in the cellulose resin, the melted product of the film forming composition can be filter by a filter 2.

As materials of the filter 2, preferably employed are conventional ones such as glass fibers, cellulose fibers, filter paper, or a fluorine contained resin such as ethylene tetrafluoride resin. Ceramics and metals are especially preferably employed. The absolute filtration accuracy of a filter employed is 50 μm or less, preferably 30 μm or less, more preferably 10 μm or less, and still more preferably 5 μm or less. These may be employed in an appropriate combination of two or more thereof. A surface or depth type filter material may be employed, and the depth type filter is preferably employed in that it is difficult to clog.

As an additive optionally contained in the film forming composition, for example, a stabilizer, a UV absorbent, a matting agent as a lubricant or a retardation controlling agent, there can be used an additive conventionally used in the optical film fields. The optical film of the invention comprises at least a thermoplastic resin and optionally a stabilizer, a UV absorbent, a matting agent as a lubricant or a retardation controlling agent.

The stabilizer restrains occurrence of volatile components due to alteration or decomposition of the materials constituting the film or deterioration of film strength. Examples of the stabilizer include a hindered phenol antioxidant, an acid trapping agent, a hindered amine light stabilizer, a peroxide decomposer, a radical trapping agent, a metal deactivating agent and amines.

As the hindered phenol antioxidant, there can be used, for example, a compound disclosed in the 12th through 14th columns in the specification of U.S. Pat. No. 4,839,405. As such a compound, there is mentioned, for example, a 2,6-dialkyl phenol derivative compound.

As the hindered phenol antioxidant, there is mentioned, for example, trade name “Irganox 1076” or “Irganox 1010” available from Ciba Specialty Chemicals.

As the acid trapping agent, there is mentioned, for example, an epoxy compound described in the specification of U.S. Pat. No. 4,137,201.

As the hindered amine light stabilizer, there can be used, for example, those as described in the 5th through 11th columns in the Specification of U.S. Pat. No. 4,619,956 and in the 3rd through 5th columns in the Specification of U.S. Pat. No. 4,839,405. Examples of the hindered amine light stabilizer include 2,2,6,6-tetraalkyl piperidine compound, a salt thereof with an acid and a complex thereof with a metal compound.

The addition amount of the stabilizer is preferably from 0.001% by weight to 5% by weight, more preferably from 0.005% by weight to 3% by weight, and still more preferably from 0.01% by weight to 0.8% by weight, based on weight of thermoplastic resin. The stabilizer may be used as an admixture of two or more kinds thereof; wherein the total addition amount of the stabilizer is within the range described above.

The plasticizer is preferably used in terms of film quality improvement such as improvement of mechanical property, improvement of flexibility or water repellency, and reduction of moisture transmittance. The plasticizer can lower a melting temperature of the film forming composition and provide a melt viscosity of the film forming composition including the plasticizer lower than that of the thermoplastic resin alone at the same heating temperature.

For example, a phosphoric acid ester derivative and a carboxylic acid ester derivative are preferably used as the plasticizer. A polymer obtained by polymerization of an ethylenically unsaturated monomer having a weight average molecular weight of from 500 to 10,000 disclosed in Japanese Patent O.P.I. Publication No. 2003-12859, an acryl polymer, an acryl polymer having an aromatic ring on the side chain, or an acryl polymer having a cyclohexyl group on the side chain is preferably used also.

Examples of the phosphoric acid ester derivative include triphenyl phosphate, tricresyl phosphate and phenyl diphenyl phosphate.

Examples of the carboxylic acid ester derivative include phthalic acid ester and citric acid ester. As the phthalic acid ester derivative, there is mentioned, for example, dimethyl phthalate, diethyl phthalate, dicyclohexyl phthalate, dioctyl phthalate or diethyl hexyl phthalate. As the citric acid ester, there is mentioned, for example, acetyl triethyl citrate or acetyl tributyl citrate.

Other plasticizers include butyl oleate, methyl acetyl ricinoleate, dibutyl sebacate, triacetin, trimethylol propane tribenzoate and the like. Alkyl phthalyl alkyl glycolate also is preferably used for the purpose as described above. The alkyl of the alkyl phthalyl alkyl glycolate is an alkyl group having a carbon atom number of from 1 to 8. Examples of the alkyl phthalyl alkyl glycolate include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate and octyl phthalyl ethyl glycolate.

The addition amount of the plasticizer is preferably from 0.5% by weight to less than 20% by weight, and more preferably from 1% by weight to less than 11% by weight, based on weight of thermoplastic resin. The plasticizers may be used as an admixture of two or more kinds thereof, wherein the total addition amount of the stabilizer is within the range described above.

It is preferred that the ultraviolet absorbent has excellent absorbance for ultraviolet light with a wavelength region of not longer than 370 nm from the viewpoint of preventing deterioration of a polarizer or a display device due to the ultraviolet light, and little absorbance for visible light having a wavelength region of not shorter than 400 nm from the viewpoint of display properties of a liquid crystal display. Examples of the ultraviolet absorbents include oxybenzophenone compounds, benzotriazole compounds, salicylic acid ester compounds, benzophenone compounds, cyano acrylate compounds, nickel complex compounds and the like. Benzotriazole compounds which have little coloration and benzophenone compounds are preferred. In addition, the ultraviolet absorbents described in Japanese Patent O.P.I. Publication Nos. 10-182621 and 08-337574, and the polymer ultraviolet absorbents described in Japanese Patent O.P.I. Publication No. 06-148430 may also be used.

TINUVIN 109, TINUVIN 171, and TINUVIN 360, (each being manufactured by Chiba Specialty Chemicals Co., Ltd.) is commercially available as the ultraviolet absorbent.

The addition amount of the ultraviolet absorbent is from 0.1 to 20% by weight, preferably from 0.5 to 10% by weight, and more preferably from 1 to 5% by weight, based on weight of thermoplastic resin used. Two or more kinds of the ultraviolet absorbent may be used in combination, and when two or more kinds of the ultraviolet absorbents are used in combination, the total amount thereof is within the above range.

A matting agent is one which improves a lubricant property, a conveyance property, a winding property and strength of the film. Matting agent particles are preferably as fine as possible. Examples of such particles include inorganic particles such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; and crosslinked polymer particles. Of these, silicon dioxide, which results in reduced haze of the film is preferred. Particles such as silicon dioxide are often subjected to surface treatment with an organic substance, and such particles are preferred which result in reduced haze.

Preferred organic materials used for the surface treatment include halosilane, alkoxysilane, silazane, or siloxane. Particles of a larger average particle size results in an enhanced lubricant effect, while those of a smaller average particle size excel in transparency. The average secondary particle size of the particles is in the range of from 0.005 to 1.0 μm, preferably from 5 to 50 nm, and more preferably from 7 to 14 nm. Incorporation of these particles in the optical film is preferred in order to form on the film surface a projection having a height of from 0.01 to 1.0 μm. The content of the particles is preferably from 0.005 to 0.3% by weight, based on weight of thermoplastic resin.

Examples of silicon dioxide particles include AEROSIL 200, 200V, 300, R972, R972V, R974, R202, R812, OX 50 and TT600 each being produced by Nihon Aerosil Co., Ltd. Of these are preferred AEROSIL 200V, R972, R972V, R974, R202 and R812. Two or more kinds of these particles may be used in combination.

It is preferred that the matting agent is added to a film forming composition before being melted or contained in advance in a film forming composition. For example, the particles and cellulose resin and/or other additives such as a plasticizer and a UV absorbent are dispersed in advance in a solvent, followed by solvent evaporation or a precipitation method, whereby the matting agent is contained in advance in the film forming composition. The matting agent can be uniformly dispersed in the thermoplastic resin by employing such a film forming composition.

The retardation controlling agent is preferably employed in an optical film, for example, a phase difference film. As the retardation controlling agent can be employed an aromatic compound containing two or more aromatic rings, described in European Patent No. 911,656 A2. Two or more kinds of the aromatic compound may be used in combination. The aromatic rings of the aromatic compound include an aromatic hydrocarbon ring and an aromatic heterocyclic ring. An aromatic heterocyclic ring is especially preferred, and such an aromatic heterocyclic ring is generally an unsaturated heterocyclic ring. Of these, it is especially preferred that the aromatic heterocyclic ring is 1,3,5-triazine ring.

When the stabilizer, plasticizer and the additives as described above are added to the thermoplastic resin, the total addition amount thereof is from 1 to 30% by weight, and preferably from 5 to 20% by weight, based on weight of the thermoplastic resin.

The film forming composition may be added with a polymer material or an oligomer, in addition to cellulose resin. Such a polymer material or an oligomer is preferably one which excels in compatibility with the cellulose ester and the film is manufactured to have a transmittance of at least 80%, preferably at least 90%, and more preferably at least 92% over the entire vigible regions (from 400 nm to 800 nm). An object of incorporating at least one of the polymer material and the oligomer in addition to the cellulose resin includes the intension to control viscosity of the film forming composition at the time of heat-melting or to improve physical properties of the manufactured film.

Resin such as cellulose resin and additives such as a stabilizer to be added as required are preferably mixed before melting. Mixing may be carried out employing a mixer and the like. Alternatively, mixing may be done during the cellulose resin preparation process, as described above. When the mixer is used, it is possible to use a general mixer such as a V-type mixer, a conical screw type mixer, a horizontal cylindrical type mixer and the like.

After the materials constituting the film have been mixed, the mixture can be directly melted by the use of the extruder 1, thereby forming a film. Alternatively, after a film forming composition has been palletized, the resulting pellets are melted in the extruder 1, thereby forming a film. Further, when the film forming composition contains a plurality of materials having different melting points, it is possible that the film forming composition is melted at such a temperature that only lower melting point materials can be melted, thereby producing a patchy half-melt and the resulting half-melt is introduced into the extruder 1 for forming a film. When the film forming composition contains materials that are easily subjected to thermal decomposition, it is preferred to use a method which forms a film directly without producing pellets for the purpose of reducing the frequency of melting or a method which produces a patchy half-melt, followed by film formation as described above.

Melt extrusion can be carried out in the same way as one used for other thermoplastic resins such as polyesters. In this case, the material is preferably dried in advance. It is desirable that drying is preferably carried out through a vacuum or low pressure dryer or a dehumidified hot air dryer so as to obtain a moisture content of 1000 ppm or less, and preferably 200 ppm or less. For example, a thermoplastic resin dried by hot air or under vacuum or reduced pressure is extruded by the extruder 1, and is melted at an extrusion temperature of about 200 to 300° C., and then filtered with the filter 2 of the leaf disk type or the like to remove foreign matter.

When the resin is introduced from a supply hopper (not illustrated) into the extruder 1, it is preferred that the introduction is carried out under vacuum or reduced pressure or under inert gas atmosphere, thereby preventing decomposition caused due to oxidation.

When an additive as a plasticizer is not mixed in advance, it can be added and kneaded during extrusion in the extruder. It is preferred that a mixing device such as a static mixer 3 is used to secure uniform addition.

As the extruder 1, an available one such as an extruder for plastic can be generally used. Various types of extruders available on the market can be used as the extruder 1, and a melt and knead extruder is preferably used. Either a single-screw extruder or a twin screw extruder may be utilized. When a film is produced directly from the film forming composition without manufacturing pellets, an appropriate kneading is required, and a twin screw extruder is preferably used. However, the single-screw extruder can be used when the form of the screw is modified into that of a kneading type screw of the Maddox type, Unimelt type or Dulmage type. This modification provides adequate kneading. When the pellets or patchy half-melt is used as a film forming composition, either a single screw extruder or a twin screw extruder can be used. It is preferred that the interior of the extruder is replaced with an inert gas such as nitrogen gas or is pressure reduced, thereby reducing a concentration of oxygen.

The preferred melting temperature of the film forming composition in the extruder 1 differs depending on viscosity or discharge amount of the film forming composition or a thickness of a sheet to be produced. Generally, the melting temperature is from Tg to Tg+100° C., and preferably from Tg+10° C. to Tg+90° C., with respect to a film having a glass transition temperature Tg. The melting viscosity at the time of extrusion is from 10 to 100000 poises, and preferably from 100 to 10000 poises. Further, the dwell time of the film forming composition in the extruder 1 is preferably shorter. This time is within 5 minutes, preferably within 3 minutes, and more preferably within 2 minutes. The dwell time depends on the type of the extruder 1 and extrusion conditions, but can be reduced by adjusting the supply amount of the composition, L/D, screw speed, or depth of the screw groove.

The shape and rotation speed of the screw of the extruder 1 are suitably selected according to the viscosity or discharge amount of the film forming composition. In the present invention, the shear rate of the extruder 1 is from 1/sec. to 10000/sec., preferably from 5/sec. to 1000/sec., and more preferably from 10/sec. to 100/sec.

The film forming composition extruded from the extruder 1 is fed to the casting die 4 and is extruded from the casting die 4 to be in the form of a film.

The melted product extruded from the extruder 1 is fed to the casting die 4. There is no restriction to the casting die 4 as long as it can be used to manufacture a sheet or a film. As the material of the casting die 4, there can be mentioned hard chromium, chromium carbide, chromium nitride, titanium carbide, titanium carbon nitride, titanium nitride, cemented carbide or ceramics (e.g., tungsten carbide, aluminum oxide, chromium oxide), each being sprayed or plated, and those which are subjected to buffing, lapping with a grinding wheel having #1000 and after, plane cutting with a diamond wheel having #1000 or more (cutting in the direction perpendicular to the resin flow), electrolytic polishing, or composite electrolytic polishing for surface treatment.

The preferred materials of the lip portions of the casting die 4 are the same as those of the casting die 4.

The melted product in the form of a film pressed with the pair of rotary rollers 5 and 6 is cooled and solidified while being conveyed by sequential contact with the second cooling roller 7 and the third cooling roller 8, whereby an unstretched film 10 is obtained.

### (Stretching and Winding Steps)

In these steps, the unstretched film 10, which has been separated from the third cooling roller 8 by the separation roller 9, is led to the stretching device 12 through the dancer roller (film tension adjusting roller) 11, stretched there, and wound by the winding device 16. The molecules in the film are oriented by this stretching step.

In the stretching step, the film is ordinarily stretched in the width direction, however, the film can be stretched in the conveyance direction (also referred to as longitudinal direction or MD direction) as well as in the width direction.

A known tenter can be preferably used in the method of stretching the film in the width direction. In particular, stretching the film in the width direction is preferred in that lamination of the film with a polarizing film can be carried out in the form of a roll. Stretching in the width direction ensures that the delayed phase axis of the optical film is oriented in the width direction.

The stretching in the conveyance direction is preferably carried out in one stage or multiple stages through one or more rollers and/or heating devices such as an infrared heater. When the stretching of the film is carried out both in the conveyance direction and in the width direction, the stretching can be simultaneously or sequentially carried out in the conveyance and width directions. When the glass transition temperature of the film in the invention is Tg, it is preferred that the film is stretched in the conveyance direction at a temperature of from (Tg−20)° C. to (Tg+100)° C., and then in the width direction at a temperature (Tg−20)° C. to (Tg+80)° C., followed by heat fixation.

With respect to the stretching magnification in the biaxial direction of the film, it is preferred that the final stretching magnification is in the range of from 1.0 to 2.0 in the conveyance direction and in the range of from 1.01 to 2.5 in the width direction. In order to obtain a required retardation value, it is more was preferred that the final stretching magnification is in the range of from 1.01 to 1.5 in the conveyance direction and in the range of from 1.05 to 2.0 in the width direction.

The known thermal fixation treatment, cooling treatment and relaxation treatment can be applied in the stretching step. Appropriate adjustment should be made to obtain characteristics required in an intended optical film.

After stretching, the ends of the film are shaved off by a slitter 13 to the width for the products. Then both ends of the film are knurled (embossed) by a knurling apparatus composed of an emboss ring 14 and back roller 15, and the film is wound by a winding device 16, whereby sticking or scratch of the optical film (stock roller) F is prevented. Knurling can be carried out, applying heat or pressure with a metallic ring having a pattern of projections and depressions on the side surface. The portions on both ends of the film which are held by the clips are normally deformed and cannot be used as film products. They are therefore cut off and are recycled as raw materials.

### [Optical Film]

The optical film of the invention sufficiently prevents thickness unevenness or optical distortion.

In the optical film obtained after the stretching step described above, the variation of the film thickness in the width direction is within the range of ±1.5%, and further ±1%, based on the average thickness. The variation of the film thickness is represented by a ratio of maximum deviation from the average thickness to average thickness, the average thickness being an average of the thicknesses obtained by measuring 30 points in the width direction of the film through a film thickness meter. The average film thickness refers to the average of the thickness in the width direction of the film excluding the both ends (margins) causing neck-in.

Further, in the optical film obtained after the stretching step described above, the variation of retardation is 10% or less, and further 5% or less. The variation of retardation is one represented by coefficient of variation (CV) in the retardation distribution obtained by measuring the retardations of the film at an interval of 1 cm in the width direction of the film. Regarding the determination of the retardation distribution, standard deviation of the retardations in plane and in the thickness direction of the film are determined according to a (n−1) method, respectively, and then, a coefficient of variation (CV) was determined from the following equation, as a measure of the retardation distribution. Herein, n is set as 130-140.

Coefficient of Variation(CV)=Standard deviation/Average of retardations

The thickness of the optical film of the invention may be appropriately selected according to its usage. When the optical film of the invention is used as a retardation film or a protective film of the polarizing plate, the thickness is preferably from 10 to 500 μm. Particularly, the lower limit of the thickness is 20 μm or more, and preferably 35 μm or more. The upper limit of the thickness is 150 μm or less, and preferably 120 μm or less. The especially preferred thickness range is from 25 to 90 μm.

Tg of the optical film is not specifically limited, however, when the optical film is used as a retardation film or a protective film of the polarizing plate, the Tg is 120° C. or higher, and preferably 135° C. or higher, in preventing change in the molecule orientation state under application environment. The Tg is preferably 250° C. or less in reducing the energy consumption during film manufacture or in preventing coloration. Tg of the film can be controlled by changing the types or proportion of the materials constituting the film.

The optical film of the invention is useful for a functional film used in various displays such as a liquid crystal display, a plasma display and an organic EL display, and particularly in a liquid crystal display. Among these, the optical film is especially suitable for a polarizing plate protective film, a phase difference film, an anti-reflection film, a luminance increasing film or an optical compensation film increasing viewing angle.

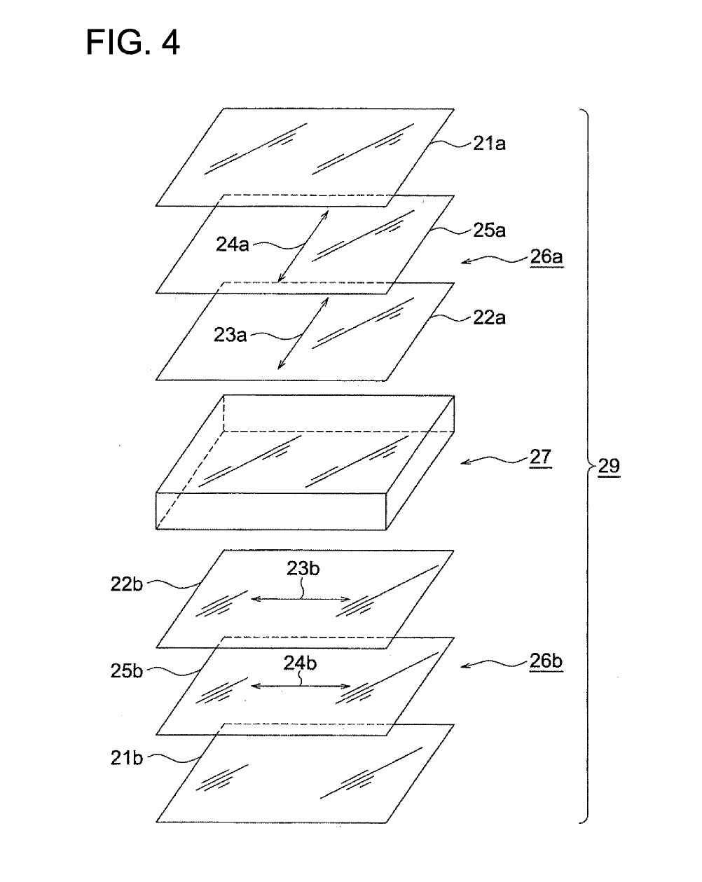

When the optical film of the invention is used as a functional film for a liquid crystal display, for example, a liquid crystal element as shown in FIG. 4 can be manufactured.

In FIGS. 4, 21a and 21b show a protective film, 22a and 22b a phase difference film, 25a and 25b a polarizer, 23a and 23b a delayed axis direction of the film, 24a and 24b a transmission axis direction of the polarizer, 27 a liquid crystal cell, and 29 a liquid crystal display. The numerical number 26a and 26b shows a polarizing plate comprising the protective film, the phase difference film and the polarizer.

In the liquid crystal display above, the optical film of the invention may be used as the protective film 21a or 21b or as the phase difference film 22a or 22b.

### EXAMPLES

The present invention will be explained in the following examples, but the invention is not limited thereto.

### Example 1

(Preparation of Pellets)

| | | |
|---|---|---|
| Cellulose acetate propionate | 100 | parts by mass |
| (A degree of substitution of an acetyl group of | | |
| 1.95, a degree of substitution of a propionyl group | | |
| of 0.7, a number average molecular weight of | | |
| 75000, a glass transition temperature Tg of | | |
| 174° C., dried at 130° C. for 5 hours) | | |
| Trimethylol propane tris(3,4,5- | 10 | parts by mass |
| trimethoxybenzoate) | | |
| IRGANOX 1010 (Produced by Ciba Specialty | 1 | part by mass |
| Chemicals Co., Ltd.) | | |
| Sumilizer GP (Produced by Sumitomo Chemical | 1 | part by mass |
| Co., Ltd.) | | |

To the materials described above, 0.05 parts by mass of silica particles Aerosil R972V (produced by Nippon Aerosil Co., Ltd.) as a matting agent and 0.5 parts by mass of TINUVIN 360 (produced by Ciba Specialty Chemicals Co. Ltd.) as a UV absorbent were added, and mixed for 30 minutes in a V-shaped mixer filled with a nitrogen gas. Thereafter, using a twin screw extruder (PCM30, produced by IKEGAI CORP.) equipped with a strand die, the resulting mixture was melted at 240° C., and cylindrical pellets with a length of 4 mm and a diameter of 3 mm were prepared. At this time, the shear rate was set at 25 (/s).

### (Manufacture of Film)

The film was manufactured employing the manufacturing apparatuses as shown in FIGS. 1 to 3.

As the shield plate, the shield plate 45a, 45b as shown in FIGS. 2 and 3 was heated and employed.

Shield plate 45a; a stainless steel plate with a thickness of 10 mm in the form of an arc concentric with the roller 5, x₁=0.3 mm, y₁=70 mm, z₁=10 mm, heat temperature=120° C.

Shield plate 45b; a stainless steel plate with a thickness of 10 mm in the form of an arc concentric with the roller 6, x₂=0.3 mm, y₂=70 mm, z₂=10 mm, heat temperature=120° C.

As the local ventilation device, the device 70 as shown in FIG. 2 was employed. α=5 mm

The first cooling roller and second cooling roller were made of stainless steel, each roller having a diameter of 40 cm, and the surface thereof were subjected to hard chromium plating. A temperature adjusting oil (fluid for cooling) was circulated inside the rollers to control the surface temperature. The elastic touch roller had a diameter of 30 cm, in which the inner cylinder and the external cylinder were made of stainless steel. The surface of the external cylinder was subjected to hard chromium plating. The external cylinder had a wall thickness of 2 mm, and a temperature adjusting oil (fluid for cooling) was circulated in the clearance between the inner cylinder and the external cylinder, whereby the surface temperature of the elastic touch roller was controlled.

The resulting pellets (with a moisture content of 50 ppm) were melted in a single screw extruder, and subjected to filtration under pressure employing a leaf disc type metal filter. Then, the resulting filtrate was melt-extruded in the form of a film at a melting temperature of 250° C. from the casting die onto the first cooling roller having a surface temperature of 100° C. to prepare a cast film with a thickness of 100 μm at a draw ratio of 10. In this case, the casting die used had a lip clearance of 1.0 mm and a lip portion having an average surface roughness Ra of 0.01 μm. The silica particles as a lubricant were added to the pellets from the opening of a hopper provided at the intermediate portion of the extruder to have a content of 0.1 parts by mass.

Herein, the film was pressed on the first cooling roller at a linear pressure of 10 kg/cm through an elastic touch roller having on the surface a 2 mm thick metal. The temperature of the film on the side of the touch roller at the time of pressing was 180° C.±1° C. (Herein, the temperature of the film on the touch roller side at the time of pressing refers to an average of the film surface temperatures at 10 points across the width of the film at the position where the touch roller is in contact with the first rotary roller (cooling roller), the film surface temperatures being measured at a position 50 cm distant from the film surface through a non-contact thermometer, after the touch roller was separated from the cooling roller so as not to be in contact with the cooling roller.) The glass transition temperature Tg of this film was 136° C. With respect to Tg, the glass transition temperature of the film extruded from the die was measured according to a DSC method (at a temperature rising rate of 10° C./minute in nitrogen atmosphere) using DSC 6200 produced by Seiko Co., Ltd.

The surface temperature of the elastic touch roller was 100° C., and the surface temperature of the second cooling roller was 30° C. The surface temperature of each of the elastic touch roller, the first cooling roller and second cooling roller was obtained as follows: The temperatures at ten points along the width of the roller surface at the position where the film contacts the roller for the first time after 90 degrees rotation of the roller were measured using a non-contact thermometer, and the average of these measurements was used as the surface temperature of each roller.

The film manufacturing speed was 20 in/min.

As the filter of the local ventilation device, CB-T-40F produced by Nippon Cambridge Co., Ltd. was employed. Employing a VXC type vapor condenser produced by Shinko Kogyo Co., Ltd. as the cooling device, the temperature of the exhaust gas in the vicinity of the outlet of the cooling device was adjusted to be 20° C.

The resulting film was introduced into a tenter having a preheating zone, a stretching zone, a retaining zone, and a cooling zone (as well as a neutral zone to ensure heat insulation between the zones), and stretched in the width direction by a magnification of 1.3 at 160° C. After that, the film was loosened 2% in the width direction and the temperature was reduced to 70° C. Then the film was released from the clip and the clip holding section was trimmed off. Both ends of the film were knurled to have a width of 10 mm and a height of 5 μm. The resulting film was slit to a width of 1430 mm. Thus, a film F-1 with a thickness of 80 μm was prepared. In this case, the preheating temperature and retaining temperature were adjusted to avoid bowing resulting from the stretching.

At the initial stage of the film formation process, a difference in pressure between the upstream and the downstream of the filter of the local ventilation device was 120 Pa, measured through a differential pressure meter. The wind speed at the tip of the suction nozzle was 0.4 m/s. The above film formation process was carried out for 10 consecutive days, but there were no deposition of the sublimate to the dies or the film manufactured. After the ten days' film formation process, that difference in pressure was 133 Pa.

The filter was observed. Deposition of a small amount of sublimates to the filter was observed, but the filter was still employable.

### Examples 2 Through 15

Films were prepared in the same manner as in Example 1, except that the shield plates 45a and 45b were used under conditions as shown in Table 1.

### Comparative Example 1

A Film was prepared in the same manner as in Example 1, except that neither of the shield plates 45a and 45b was heated.

### Comparative Example 2

A Film was prepared in the same manner as in Example 1, except that neither of the shield plates 45a and 45b was provided.

### (Evaluation)

### Evaluation According to Cross Nicol Arrangement

Each film prepared above was provided between two polarizing plates arranged orthogonal to each other, and unevenness was visually observed.

A: No unevenness is observed.

B: A slight unevenness is observed, but there is no practical problem.

C: Apparent unevenness is observed, and there is practical problem.

TABLE 1

| | a | b | c | d | e | Remarks |
|---|---|---|---|---|---|---|
| Ex. 1 | 0.3 | 120 | 70 | 10 | B | — |
| Ex. 2 | 1.5 | 120 | 70 | 10 | A | — |
| Ex. 3 | 3 | 120 | 70 | 10 | A | — |
| Ex. 4 | 7 | 120 | 70 | 10 | A | — |
| Ex. 5 | 10 | 120 | 70 | 10 | A | — |
| Ex. 6 | 20 | 120 | 70 | 20 | B | — |
| Ex. 7 | 7 | 50 | 70 | 20 | B | — |
| Ex. 8 | 7 | 80 | 70 | 20 | A | — |
| Ex. 9 | 7 | 150 | 70 | 20 | A | — |
| Ex. 10 | 7 | 250 | 70 | 20 | A | — |
| Ex. 11 | 7 | 270 | 70 | 30 | B | — |
| Ex. 12 | 7 | 150 | 5 | 30 | B | — |
| Ex. 13 | 7 | 150 | 50 | 30 | A | — |
| Ex. 14 | 7 | 150 | 150 | 30 | A | — |
| Ex. 15 | 7 | 150 | 350 | 50 | B | — |
| Comp. Ex. 1 | 7 | 25 | 150 | 20 | C | f |
| Comp. Ex. 2 | — | — | — | — | C | g |

Ex.: Example, Comp. Ex.: Comparative Example
a: Clearance Between Shield Plate and Roller (x₁, x₂) [mm]
b: Temperature Of Shield Plate [° C.]
c: Circumference Length Of Shield Plate (y₁, y₂) [mm]
d: z₁ and z₂ [mm]
e: Unevenness According To Cross Nicol Arrangement
f: The shield plates were not heated.
g: No shield plate was provided.

1-9. (canceled)

10. A method of manufacturing an optical film comprising the steps of:
extruding a melted film forming composition containing a thermoplastic resin from lip portions of a casting die to form a melted product in the form of a film;
holding the resulting melted product at a nip formed between a pair of rotary rollers which rotate in opposite directions, thereby cooling and solidifying the melted product; and
heating a shield plate, which is provided in the vicinity of an inlet of the nip and in the vicinity of the surface of at least one of the pair of rotary rollers, thereby heating an air stream occurring upon rotation of the rotary rollers and colliding with the melted product before held at the nip.

11. The method of manufacturing an optical film of claim 10, wherein the shield plate provided in the vicinity of the surface of the rotary roller is in the form of an arc concentric with the rotary roller in the cross-section perpendicular to the axis direction of the rotary roller.

12. The method of manufacturing an optical film of claim 10, wherein a clearance between the rotary roll and the shield plate provided in the vicinity of the surface of the rotary roll is from 0.5 to 10 mm.

13. The method of manufacturing an optical film of claim 10, wherein the shield plate provided in the vicinity of the surface of the rotary roller has a length of from 10 to 300 mm in the rotation direction of the rotary roller.

14. The method of manufacturing an optical film of claim 10, wherein the shield plate is heated to from 80 to 260° C.

15. The method of manufacturing an optical film of claim 10, wherein gas containing a sublimate generated from the melted product extruded from the lip portions is sucked through a suction nozzle disposed on one or both sides of the lip portions over the entire length of the lip portions.

16. The method of manufacturing an optical film of claim 15, wherein the suction nozzle is disposed between the shield plate and the casting die.

17. An apparatus of manufacturing an optical film the apparatus comprising:
a casting die with lip portions for extruding a melted film composition containing a thermoplastic resin to form a melted product in the form of a film;
a shield plate to be heated;
a pair of rotary rollers; and
a nip formed between the pair of rotary rollers,
wherein the shield plate is provided in the vicinity of an inlet of the nip and in the vicinity of the surface of at least one of the pair of rotary rollers, and the melted product is held at the nip to be cooled and solidified.
